(19) United States
(12) Patent Application Publication
(10) Pub. No.: US 2015/0121084 A1
(43) Pub. Date: Apr. 30, 2015

(54) SECURE MESSAGE TRANSMISSION

(71) Applicant: ABB RESEARCH LTD, Zurich (CH)

(72) Inventors: Hubert KIRRMANN, Dattwil (CH); Cagri ÖNAL, Baden (CH)

(73) Assignee: ABB RESEARCH LTD, Zurich (CH)

(21) Appl. No.: 14/585,746

(22) Filed: Dec. 30, 2014

Related U.S. Application Data
(63) Continuation of application No. PCT/EP2013/062027, filed on Jun. 11, 2013.

(30) Foreign Application Priority Data
Jul. 3, 2012 (EP) 12174736.4

(51) Int. Cl. H04L 9/32; H04L 9/06

(52) U.S. Cl. CPC H04L 9/3247; H04L 9/0618; H04L 9/3242
USPC 713/176

(57) ABSTRACT

A method and system are provided for securing messages within a communication network of an industrial process control system, such as a substation automation system. A multi-block message to be transmitted via a communication network is secured by a block-based authentication, encryption and/or integrity information. Only residue of the previous block in the form of block-based information is needed to generate the block based information of the next block. Therefore, the previous block can already be transmitted while block-based information of the next block is generated. The method and system of the present disclosure enable on-the-fly authentication of the multi-block message and authentication at an increased rate.

### RELATED APPLICATIONS

This application is a continuation of PCT/EP2013/062027, which was filed as an International Application on Jun. 11, 2013, and which claims priority to European Application 12174736.4 filed in Europe on Jul. 3, 2012. The entire contents of these applications are hereby incorporated by reference in their entireties.

### FIELD

The present disclosure relates to the field of securing messages within a communication network of an industrial process control system, such as a substation automation system, for example. The present disclosure provides a method and a system for securing messages.

### BACKGROUND INFORMATION

In a communication network, securing messages is of great importance for accurate and safe operation. Different levels of security are utilized depending on a potential threat to the network. In the case of malicious messages being a threat to the network, a method of message authentication may be sufficient to protect the network. In the case of eavesdropping being a threat, a more complex method such as message encryption may be needed to protect the network. Further objectives may be the prevention of playback and spoofing, as well as intrusion detection.

However, securing messages is time consuming and costly. According to known techniques, securing a message requires a great amount of time compared to the time actually needed for handling the message.

For authentication, a sender generates, based on the message contents, a signature known as a message authentication code (MAC), appends the MAC to the message, and finally sends the message with the appended MAC via the network. Specifically, the sender generates the signature from an authentication algorithm, and a receiver can authenticate the sender by checking the signature. The authentication algorithm may be asymmetrical or symmetrical, the latter including, for example, hashed message authentication code (HMAC), Galois field MAC (GMAC) and secure cipher block chaining MAC (XCBCMAC). Known implementations of the algorithms for authentication require the message to be entirely received before generating the signature authentication, which results in large processing overhead. Accordingly, known authentication techniques cause significant delays for transmitting and forwarding of messages within the communication network. As a result, although enhanced security is needed, authentication is not applied as of time constraints for transmitting messages.

EP 1 615 370 describes such a method for authenticating short messages. A MAC is calculated for a message by a sending module. The length of the MAC is limited. The MAC is transmitted along with the message to a receiving module via a communication link. The receiving module calculates a MAC independently for the received message. If the calculated MAC matches the received MAC, the received message is declared provisionally authentic. The message is declared fully authentic when a predefined number of subsequent messages have been declared provisionally authentic.

In the case of substation automation according to the IEC 61850 standard, the security scheme to be used is described in the IEC 62351 standard. The different security objectives include authentication of data transfer through digital signatures, ensuring authenticated access, prevention of eavesdropping, prevention of playback and spoofing, and intrusion detection. However, there are no known commercial applications to this point. Furthermore, the high overhead to security features may prevent the network from fulfilling its real-time constraints. For instance, in the case of a hash and sign paradigm for digital signature creation, asymmetrical algorithms are much more time consuming than symmetrical algorithms and tend to violate the real time requirements of substation automation systems. Thus, asymmetrical encryption algorithms are rarely used, particularly in the case of substation automation.

Furthermore, transmitting and forwarding of a message within the communication network is delayed by performing an integrity check operation. The integrity check allows for accidental or malicious modifications to the message to be uncovered by generating a checksum. A checksum is computed from a block of the message for detecting errors that may have been introduced during transmission or storage. The integrity of the data can be checked at any time thereafter by re-generating the checksum and comparing it with the checksum of the message received.

### SUMMARY

An exemplary embodiment of the present disclosure provides a method for securing a multi-block message in a communication network of an industrial process control system. The exemplary method includes generating block authentication information for a block of the message based on characters of the block and based on block authentication information of a previous block while transmitting or forwarding the previous block of the message. The exemplary method also includes generating a message authentication signature as a summary of the authentication information of each block of the message. In addition, the exemplary method includes appending the authentication signature to a final block of the message, or verifying a received authentication signature of the message.

An exemplary embodiment of the present disclosure provides a communication network system of an industrial process control system. The communication network system includes a communication network device configured to secure a multi-block message in the communication network. The communication network device includes a processor configured to: generate block authentication information for a block of the message based on the characters of the block and based on block authentication information of a previous block while transmitting the previous block of the message; encrypt a block of the message while transmitting an encrypted previous block of the message; generate a message authentication signature based on a summary of the authentication information of each block of the message; and append the authentication signature to a final block of the message, or verify a received authentication signature appended to the message.

An exemplary embodiment of the present disclosure provides a non-transitory computer-readable recording medium having a computer program recorded thereon that, when executed by a processor of a communication network device, causes the communication network device to carry out a method of securing a multi-block message in a communication network of an industrial process control system. The method includes generating block authentication information for a block of the message based on characters of the block and based on block authentication information of a previous block while transmitting or forwarding the previous block of the message. The method also includes generating a message authentication signature as a summary of the authentication information of each block of the message. In addition, the method includes appending the authentication signature to a final block of the message, or verifying a received authentication signature of the message.

### BRIEF DESCRIPTION OF THE DRAWINGS

Additional refinements, advantages and features of the present disclosure are described in more detail below with reference to exemplary embodiments illustrated in the drawings, in which:

FIG. 1 schematically shows a communication device with an incoming multi-block message and an outgoing multi-block message, according to an exemplary embodiment of the present disclosure;

FIG. 2 schematically shows a process of generating an authentication to be appended to an outgoing message, according to an exemplary embodiment of the present disclosure; and

FIG. 3 schematically shows a process of authentication and encryption of an outgoing message, according to an exemplary embodiment of the present disclosure.

The reference symbols used in the drawings, and their meanings, are listed in summary form in the list of reference symbols. In principle, identical or similarly functioning parts are provided with the same reference symbols in the drawings.

### DETAILED DESCRIPTION

An objective of the present disclosure is to accelerate the process of securing a message within a communication network of an industrial process control system, in particular a substation automation system. Exemplary embodiments of the present disclosure provide a method for securing a multi-block message and a communication network system which achieve this objective.

According to an exemplary embodiment of the present disclosure, a plain text multi-block message including characters arranged in blocks of a single size is to be transmitted between devices over a communication network of an industrial process control system, for example, a substation automation system, or to be forwarded to upper layers of a communication stack of a device of such system. The multi-block message is to be secured by way of a block-based authentication code processing the blocks of the message in a serial manner, wherein authentication information of a non-initial block of the message is generated based on authentication information of a previous block that was processed earlier. Thus, only residue of the previous block in the form of the authentication information is needed to generate the authentication information of the next block. Therefore, the previous block can already be further processed, for example, the previous block can already be transmitted or forwarded respectively while authentication information of the next block is generated. This enables on-the-fly authentication of the multi-block message and authentication at an increased rate of more than 1 Gbit/s. Further, this allows use of simplified devices for securing messages and a reduction in the computation costs.

Ultimately, authentication information of a final block (e.g., the last block of the message to be processed) includes a summary of the authentication information of each block of the multi-block message and may be considered a message authentication signature for the entire multi-block message. Subsequently, such signature is appended to the message (e.g., to the final block of the message). From the summary, the authentication information of each block can be checked after the message is received by another communication network device or further layers of the same device.

In contrast to EP 1 615 370, exemplary embodiments of the present disclosure generate, at first, the block authentication information based on characters of the block and the block authentication information of the previous block. This is performed during the transmission of the previous block of the message. Then, the authentication signature (MAC) is generated as the summary of the authentication information of each block of the message.

For authentication of the received message, the block-wise authentication information and finally the authentication signature is re-generated after receiving the message. The original authentication signature of the received message is cross-checked with the re-generated signature. For matching signatures, the received message is considered secure and authenticated.

An exemplary embodiment of the present disclosure provides the use of the above-described features within precision time protocols (PTP) such as the IEEE 1588 standard for precise time distribution and clock synchronization in electrical substations, wherein the use of a chained MAC (CMAC) as authentication is particularly advantageous. Furthermore, for IEC 62439-3 (HSR), the delay caused by securing the message is well below the required 5 μs maximum residence time of the message. Detailed investigations are being published in C. Önal and H. Kirrmann, International IEEE Symposium on Precision Clock Synchronization for Measurement, Control and Communication, San Francisco, 2012.

In accordance with an exemplary embodiment of the present disclosure, the multi-block message to be secured is to be checked for integrity after being received by a communication network device. The integrity check is introduced for the purpose of detecting accidental errors that may have occurred during transmission or storage of the message. Some integrity check operations may be based on special algorithms that not only detect errors but also allow the original data to be recovered in certain cases.

According to an exemplary embodiment of the present disclosure, the integrity check operation is block based, wherein the blocks may be different from the blocks used for authentication. This way, the algorithm for the integrity check can be optimized with respect to size of the used blocks particularly by number of characters or certain bits of the message.

However, the operation is carried out in parallel to the authentication of the multi-block message and in a similar fashion. An integrity check value is generated for a block of the message based on a specific residue of a previous block. Similar to the operation of authentication, this enables an on-the-fly integrity check of the multi-block message and an integrity check at an increased speed. Finally, a checksum is generated from the integrity check value of each block of the message and appended to a final block. The integrity of an incoming message can be checked by re-generating the integrity check value and ultimately the checksum, and by subsequent comparison of the received and re-generated checksum. In case of matching checksums, the integrity of the incoming message is verified.

In accordance with an exemplary embodiment of the present disclosure, the multi-block message is encrypted for enhanced confidentiality and further security. Standards and cryptographic software as well as hardware to perform encryption are widely available, but successfully using encryption to ensure security is challenging. According to this embodiment of the present disclosure, encryption is carried out on-the-fly and concurrent with, or in parallel to, authentication and the integrity check operation. For example, a block based algorithm is used for encryption, wherein a single shared block cipher may even be used both to encrypt and to calculate an authentication signature.

According to an exemplary embodiment, it may be advantageous to generate the authentication information of a block before or after encryption of the block depending on the algorithms used for each operation, for example, when using the same block size for authentication and encryption; authentication may also be carried out after encryption of the message blocks. In case a shared cipher or encryption engine is used, intermediate authentication signature values can be obtained from the manipulation of the encrypted input data blocks (or vice versa).

The present disclosure also relates to a communication network system of an industrial process control system, for example, a substation automation system including a communication network device configured to securing a multi-block message. The communication network device is configured to separate the message in sorted blocks and apply a block-based security code. The block authentication information for a block of the message is generated based on residue of the block and based on block authentication information of a previous block while transmitting the previous block of the message. Each block of the message is encrypted while an encrypted previous block is transmitted. A message authentication signature is generated based on the block authentication information of a final block of the message, and ultimately the authentication signature is appended to the final block of the message or a received authentication signature appended to the message is verified.

Accordingly, the message is transmitted or forwarded respectively while some of the content is still processed in the form of generating authentication, generating the checksum or encrypting the message. This way, the time delay for processing of the message is reduced to a minimum, thus enabling on-the-fly security for the communication network at a high transmitting rate at low computation costs.

Exemplary embodiments of the present disclosure are described hereinafter in terms of the functions performed by a communication network device. It is to be understood that the functions of the communication network device as described hereinafter are each respectively implemented in one or more computer processing devices configured to individually and/or collectively perform the functions of the communication network device. Such computer processing devices may be a personal computer or server computer each appropriately programmed to carry out the respective functions of the devices as described herein. The computer processing devices each include a processor and a non-transitory computer-readable recording medium, which is a non-volatile memory such as a ROM, hard disk drive, flash memory, optical memory, etc. The non-transitory computer-readable recording medium has tangibly recorded thereon a computer program and/or computer-readable instructions which, when executed by the processor of the computer processing device, causes the processor to perform the operative functions of the devices as described herein. The processor may be a general-purpose processor such as those produced by Intel® or AMD®, for example. Alternatively, the processor may be an application specific processor which is specifically designed for the computer(s) of the respective device(s).

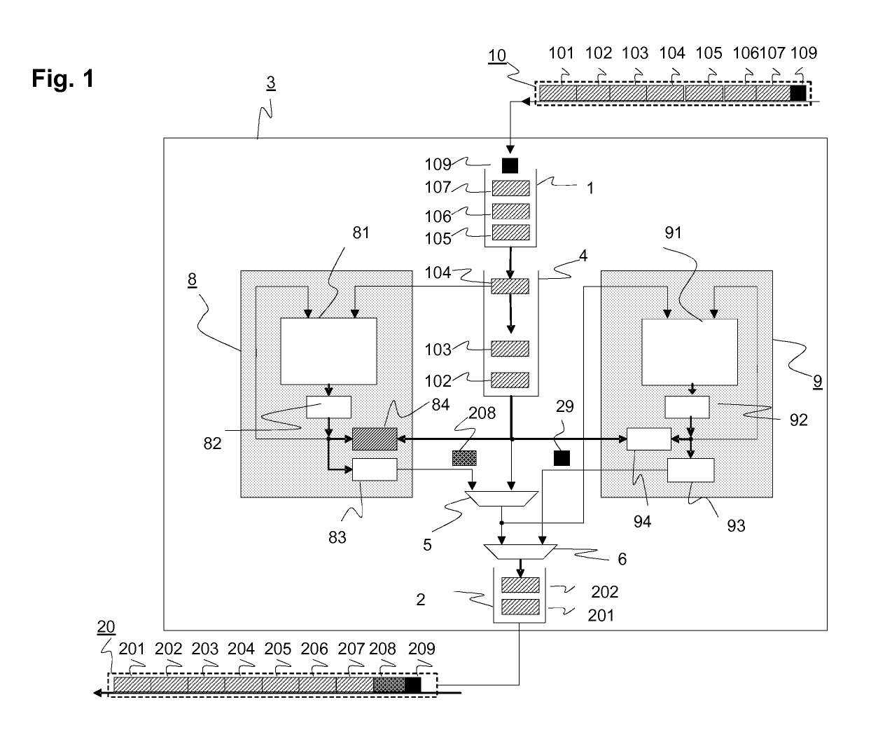

FIG. 1 shows schematically an exemplary embodiment of securing of an multi-block message 100 using a communication network device 3. The device 3 includes a message input 1 and a message output 2, a distributor 4, two signature compilers 5, 6, an authentication operator 8, and an integrity check operator 9. The multi-block message 100 includes a preamble block 101, content blocks 102, 103, 104, 105, 106, 107 and a final block 109 containing an integrity checksum. The message 100 is first received by the network device 3 via the input 1, wherein the message is separated and sorted by blocks 102, 103, 104, 105, 106, 107. The final block 109 containing the integrity checksum is removed by the message input 1.

Subsequently, the distributor 4 forwards the blocks 102, 103, 104, 105, 106, 107 one by one to the authentication operator 8 and the integrity check operator 9, wherein the blocks 102, 103, 104, 105, 106, 107 can be different in size for the authentication operator 8 and the integrity check operator 9. This way, the block size can be optimized to fit the respective algorithm for authentication and generation of the integrity checksum.

For authentication, the operator 8 receives and processes the message block by block, wherein after an authentication information is generated for one block 102, 103, 104, 105, 106, 107 by a block processor 81, the next block 102, 103, 104, 105, 106, 107 is received from the distributor 4. A post processor 82 transmits the authentication information to a shuffling unit 83 in case this is required by the authentication algorithm, wherein the shuffling unit 83 computes an authentication signature from the authentication information. In addition, residue or characters needed to calculate the authentication information of the next block 102, 103, 104, 105, 106, 107 is temporarily stored in a storage unit 84 to be re-directed to the block processor 81.

The shuffling unit 83 sends the generated authentication signature 208, 508 to a compiler 5, where the signature 208, 508 is appended to the final block 107 of the message 100. The blocks 102, 103, 104, 105, 106, 107 are forwarded to the message output 2 of the network device 3, where the blocks 102, 103, 104, 105, 106, 107 are transmitted on-the-fly to a further network communication device.

Respectively, an integrity checksum 209 is generated by an integrity check operator 91 in parallel to authentication, where the procedure is equivalent to the generation of the authentication information 502, 503, 504, and a signature 208, 508 apart from an integrity information and a checksum to be generated for each block 102, 103, 104, 105, 106, 107. A shuffling unit 93 forwards the integrity checksum to a compiler 6, which appends the integrity checksum 209 to the authentication signature 208, 508 of the message 100. For specific algorithms, the authentication signature 208, 508 may be included in the generation of the integrity checksum 209, where the authentication operator 81 exchanges the necessary information such as the authentication signature 208, 508 with the integrity check operator 91, or vice versa.

Ultimately, the outgoing message 200 is transmitted on-the-fly and includes general content blocks 201, 202, 203, 204, 205, 206, 207, the authentication signature block 208 and the integrity checksum 209.

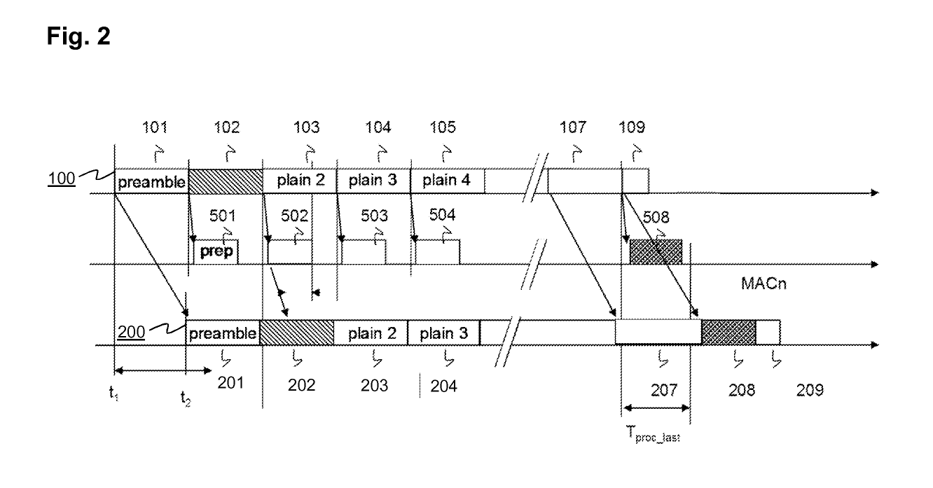

FIG. 2 shows schematically the process of securing a multi-block message 100 by authentication, according to an exemplary embodiment of the present disclosure. A header 101 or preamble of the message is used as preparation information 501 to form the header of the outgoing message 200. For each block 102, 103, 104, 105, 106, 107 of the message 100, authentication information 502, 503, 504 is generated and stored temporarily. The authentication signature 508 is then generated from the stored authentication information 502, 503, 504. For transmitting the outgoing message 200, the preamble 201 and each block 202, 203, 204, 207 is transmitted on-the-fly while the authentication signature 508 is generated. Finally, the authentication signature 208 and the generated integrity checksum 209 are appended to the final block 207 of the message 200.

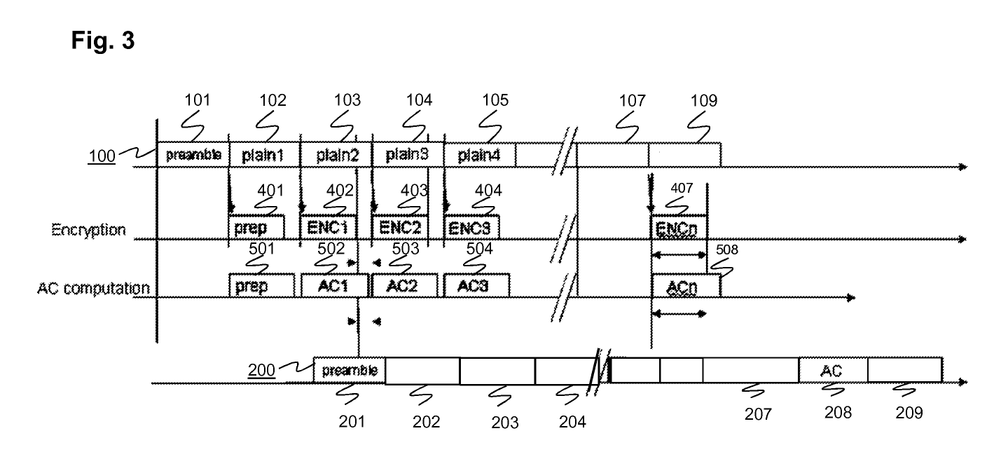

FIG. 3 shows schematically the process of securing the multi-block message 100 by encryption and authentication, according to an exemplary embodiment of the present disclosure. The process is carried out as described in FIG. 2 aside from the blocks 102, 103, 104, 105, 106, 107 of the message 100 being encrypted before the authentication information 502, 503, 504 is generated. For encryption, encrypted blocks 401, 402, 403, 404, 407 are generated from the original blocks 101, 102, 103, 104, 107. The authentication information 502, 503, 504 is generated for each encrypted block 401, 402, 403, 404, 407. Ultimately, the authentication signature 208, 508 and the in parallel generated integrity checksum 209 are appended to the final block 207 of the message 200.

However, one skilled in the art will understand that the message 100 to be secured can be of indefinite length. According to an exemplary embodiment of the present disclosure, a time delay for sending a message 200 is only introduced for processing the final block 207. Previous blocks 202, 203, 204 are already sent while the next block 202, 203, 204 is secured, thus not causing any time delay.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF REFERENCE SYMBOLS

1 Input
2 Output
3 Device
4 Distributor
5, 6 Compiler
8 Authentication operator
9 Integrity check operator
81 Block processor
82 Post processor
83 Shuffling unit
84 Storage unit
91 Block processor
92 Post register
93 Shuffling unit
94 Storage unit
100 Multi-block message
101 Header
102-106 Block
107 Final block
109 Integrity checksum
200 Multi-block message
201 Preamble
202-206 Block
207 Final block
208 Authentication signature
209 Integrity checksum
401 Preamble information
402-408 Encrypted block
501 Preamble information
502-504 Authentication information
508 Authentication signature

What is claimed is:

1. A method for securing a multi-block message in a communication network of an industrial process control system, the method comprising:
generating block authentication information for a block of the message based on characters of the block and based on block authentication information of a previous block while transmitting or forwarding the previous block of the message;
generating a message authentication signature as a summary of the authentication information of each block of the message; and
appending the authentication signature to a final block of the message, or verifying a received authentication signature of the message.

2. The method according to claim 1, comprising:
encrypting a block of the message while transmitting an encrypted previous block of the message.

3. The method according to claim 2, comprising:
encrypting a block of the message, while generating the block authentication information of an encrypted previous block of the message.

4. The method according to the claim 1, comprising:
verifying the received authentication signature by comparing the received authentication signature with the generated authentication signature.

5. The method according to claim 1, comprising one of:
transmitting the message to a second communication network device via a communication network; and
forwarding the message to an upper layer of a communication stack of the communication network device.

6. The method according to claim 1, comprising performing an integrity check operation, the integrity check operation including:
generating an integrity check value for a block of the message based on the characters of the block and based on the integrity check value of the previous block while transmitting the previous block of the message;
generating an integrity checksum based on the integrity check value of the blocks of the message; and
appending the integrity checksum to the message when transmitting the message, or verifying a received integrity checksum of the message when receiving the message.

7. The method according to claim 6, wherein the integrity check operation is performed after appending the authentication signature to the message for outgoing messages, or before removing the authentication signature from the message for incoming messages.

8. The method according to claim 1, comprising:
appending a tag to the message indicative of a failed authentication for forwarding the message to an upper layer processing unit of a communication network device.

9. The method according to claim 1, wherein the industrial process control system is a substation automation system.

10. The method according to claim 1, wherein the authentication signature is appended to the final block of the message when transmitting the message, or the received authentication signature of the message is verified when receiving the message.

11. The method according to claim 2, comprising performing an integrity check operation, the integrity check operation including:
generating an integrity check value for a block of the message based on the characters of the block and based on the integrity check value of the previous block while transmitting the previous block of the message;
generating an integrity checksum based on the integrity check value of the blocks of the message; and
appending the integrity checksum to the message when transmitting the message, or verifying a received integrity checksum of the message when receiving the message.

12. The method according to claim 11, wherein the integrity check operation is performed after appending the authentication signature to the message for outgoing messages, or before removing the authentication signature from the message for incoming messages.

13. The method according to claim 3, comprising performing an integrity check operation, the integrity check operation including:
generating an integrity check value for a block of the message based on the characters of the block and based on the integrity check value of the previous block while transmitting the previous block of the message;
generating an integrity checksum based on the integrity check value of the blocks of the message; and
appending the integrity checksum to the message when transmitting the message, or verifying a received integrity checksum of the message when receiving the message.

14. The method according to claim 13, wherein the integrity check operation is performed after appending the authentication signature to the message for outgoing messages, or before removing the authentication signature from the message for incoming messages.

15. The method according to claim 4, comprising performing an integrity check operation, the integrity check operation including:
generating an integrity check value for a block of the message based on the characters of the block and based on the integrity check value of the previous block while transmitting the previous block of the message;
generating an integrity checksum based on the integrity check value of the blocks of the message; and
appending the integrity checksum to the message when transmitting the message, or verifying a received integrity checksum of the message when receiving the message.

16. The method according to claim 15, wherein the integrity check operation is performed after appending the authentication signature to the message for outgoing messages, or before removing the authentication signature from the message for incoming messages.

17. The method according to claim 5, comprising performing an integrity check operation, the integrity check operation including:
generating an integrity check value for a block of the message based on the characters of the block and based on the integrity check value of the previous block while transmitting the previous block of the message;
generating an integrity checksum based on the integrity check value of the blocks of the message; and
appending the integrity checksum to the message when transmitting the message, or verifying a received integrity checksum of the message when receiving the message.

18. The method according to claim 17, wherein the integrity check operation is performed after appending the authentication signature to the message for outgoing messages, or before removing the authentication signature from the message for incoming messages.

19. A communication network system of an industrial process control system, the communication network system comprising a communication network device configured to secure a multi-block message in the communication network, the communication network device including a processor configured to:
generate block authentication information for a block of the message based on the characters of the block and based on block authentication information of a previous block while transmitting the previous block of the message;
encrypt a block of the message while transmitting an encrypted previous block of the message;
generate a message authentication signature based on a summary of the authentication information of each block of the message; and
append the authentication signature to a final block of the message, or verify a received authentication signature appended to the message.

20. The communication network system according to claim 19, wherein the communication network device is located before one of a physical network interface, in-between two network interfaces, and before several output queues of a multiport bridging device.

21. The communication network system according to claim 19, wherein the industrial process control system is a substation automation system.

22. The communication network system according to claim 19, wherein the processor is configured to append the authentication signature to the final block of the message when transmitting the message, or verify the received authentication signature of the message when receiving the message.

23. A non-transitory computer-readable recording medium having a computer program recorded thereon that, when executed by a processor of a communication network device, causes the communication network device to carry out a method of securing a multi-block message in a communication network of an industrial process control system, the method comprising:
generating block authentication information for a block of the message based on characters of the block and based on block authentication information of a previous block while transmitting or forwarding the previous block of the message;
generating a message authentication signature as a summary of the authentication information of each block of the message; and
appending the authentication signature to a final block of the message, or verifying a received authentication signature of the message.
